(19) United States
(12) Patent Application Publication
(10) Pub. No.: US 2018/0313696 A1
(43) Pub. Date: Nov. 1, 2018

(54) Temperature Monitoring Systems and Processes

(71) Applicant: Wello, Inc., Addison, TX (US)

(72) Inventors: Alan C. Heller, Dallas, TX (US); Alexander Shields, Dallas, TX (US); Scott Cadieux, Dallas, TX (US)

(21) Appl. No.: 15/964,004

(22) Filed: Apr. 26, 2018

Related U.S. Application Data
(60) Provisional application No. 62/491,166, filed on Apr. 27, 2017.

(51) Int. Cl. G01K 1/02; G01K 13/00; G01J 5/10; H04N 5/33

(52) U.S. Cl. CPC G01K 1/024; H04N 5/33; G01J 5/10; G01K 13/00

(57) ABSTRACT

The present invention is directed to systems and processes for monitoring temperature of food and other substrates. Embodiments include a temperature sensor configured to provide temperature reading output of the food, a computer comprising a processor, memory, a network adapter, and a reporting database, the reporting database configured to store temperature reading output of the food.

### BACKGROUND

### Field of the Invention

The present invention is directed to temperature monitoring systems and processes, more specifically to systems and processes for obtaining temperature data for food and other substrates.

### Description of the Related Art

In some settings, food is served by placing it in containers and setting it out for patrons for self-service access to it. In order to assure food safety, the temperature of the food may be monitored prior to consumption. In such settings, a temperature sensor can provide a readout of the temperature. An operator is employed to monitor and record the readings of these sensors. The operators are typically required to record the readings of the sensors periodically. The operators walk to the location of the food where the sensor reading is present and record the readings.

### SUMMARY

Certain embodiments of the present invention are directed to systems and processes for monitoring temperature of food and other substrates. Embodiments include a temperature sensor configured to provide temperature reading output of the food, a computer comprising a processor, memory, a network adapter, and a reporting database, the reporting database configured to store temperature reading output of the food.

These and other features, aspects, and advantages of the invention will become better understood with reference to the following description, and accompanying drawings.

### BRIEF DESCRIPTION OF THE DRAWINGS

FIG. 1 depicts a diagram of an embodiment of a system of the current invention as it may exist in operation;

FIG. 2 depicts a diagram of an embodiment of a system of the current invention as it may exist in operation;

FIG. 3 depicts a diagram of an embodiment of a system of the current invention as it may exist in operation;

FIG. 4 depicts a diagram of an embodiment of a system of the current invention as it may exist in operation;

FIG. 5 depicts a diagram of an embodiment of a system of the current invention as it may exist in operation;

FIG. 6 depicts a diagram of a configuration of a temperature sensor system of the current invention;

FIG. 7 depicts a diagram of a configuration of an optical sensor system of the current invention;

FIG. 8 depicts a diagram of a configuration of a heat wick of the current invention as it may exist in operation;

FIG. 9 depicts a top view of monitored food as it may be processed by the current invention;

FIG. 10 depicts various, separated food as it may exist in operation;

FIG. 11 depicts various alphanumeric data;

FIG. 12A depicts a flowchart of an embodiment of a subprocess of the current invention;

FIG. 12B depicts a flowchart of an embodiment of a subprocess of the current invention; and

FIG. 13 depicts a flowchart of an embodiment of a process of the current invention.

### DETAILED DESCRIPTION

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

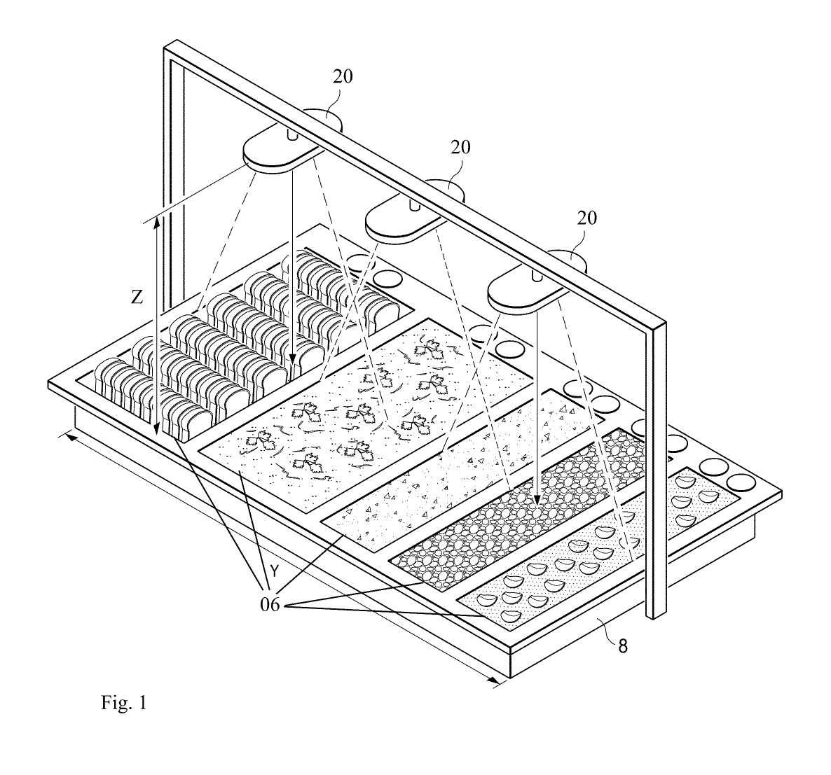

Certain embodiments of the present invention are directed to systems and processes to obtain temperature readings from a remote substrate, such as food. FIGS. 1-5 illustrate embodiments of systems of the present invention as they may exist in operation. Depicted are temperature sensors 20, optical sensors 12, and a computer 30.

Illustrated is are sensors 12 20. Sensors, as used within the specification means a device that measures a physical property within the subject environment and converts it into a signal which can be read by an observer or device. In common sensors, the sensor output is transformed to an electrical signal encoding the measured property. It is to be understood that sensor signal may be output in other formats such as digital data, bar code data, visual indicators, or other formats known in the art. The sensor can incorporate a power source and local memory for storage of output, time stamps, and related sensor data. Sensors can include, but are not limited to temperatures sensors, pressure sensors, voltage sensors, light sensors, motion sensors, chemical sensors, biological sensors, and the others known in the art.

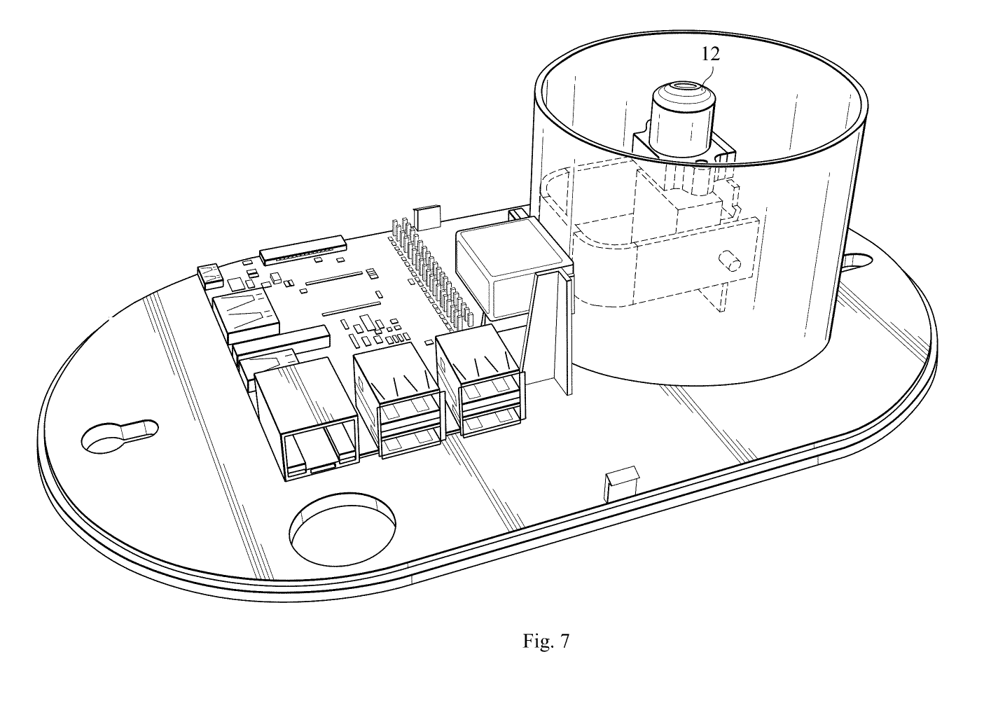

An exemplary optical sensor 12 is an optical camera 12 is illustrated in FIG. 7. Suitable cameras include simple optical cameras, color or black and white. Other suitable cameras includes those integrated with a handheld computer 30. Other suitable cameras include zoom functionality, such as optically with lenses or electronically by image processing. Other suitable cameras may be integrated in other devices. For example, the camera 12 may be incorporated into a smartphone, webcam, video monitoring system, or the like. In certain configurations, the optical sensor 12 includes a pivotal mount, enabling selective adjustment of the field of view 14.

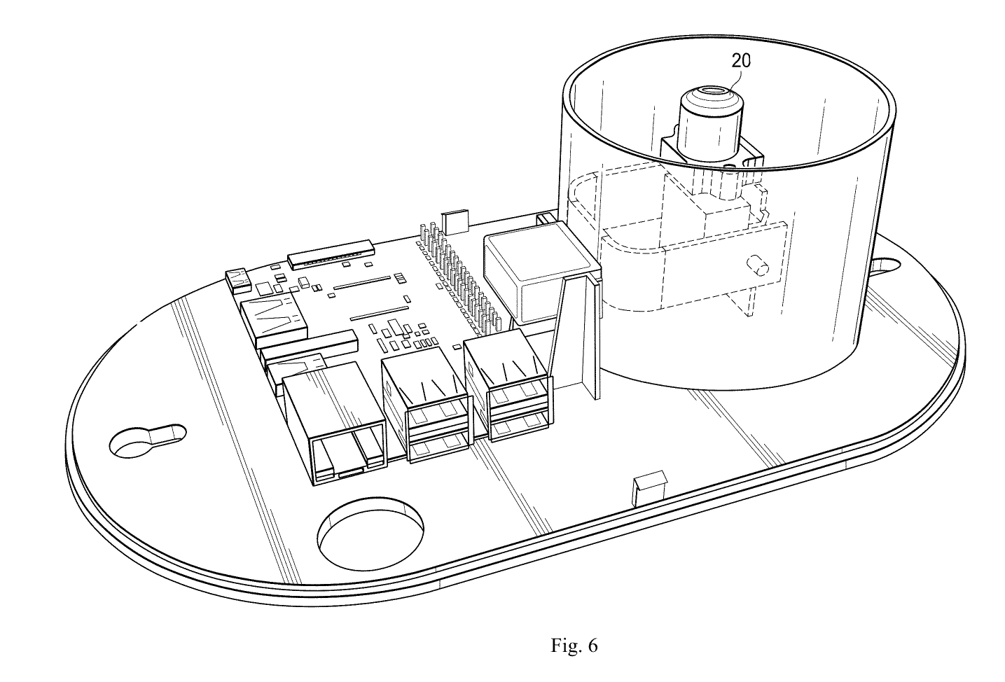

An exemplary temperature sensor 20 is illustrated in FIG. 6. Among the suitable temperature sensors is remote temperature sensor, such as an infra-red heat sensor. Since energy related directly to heat is in the band commonly referred to as “far infrared,” or 4-14 μm in wavelength (4,000 to 14,000 nm), this is the suitable range for infra-red measuring of temperatures. Another suitable temperature sensor 20 is one which includes a temperature probe. Another suitable temperature sensor 20 is one which includes a wireless transmitter for transmission of sensor data. Another suitable temperature sensor 20 includes a sensor readout region 22, with the sensor readout region 22 displaying alphanumeric sensor readings 24.

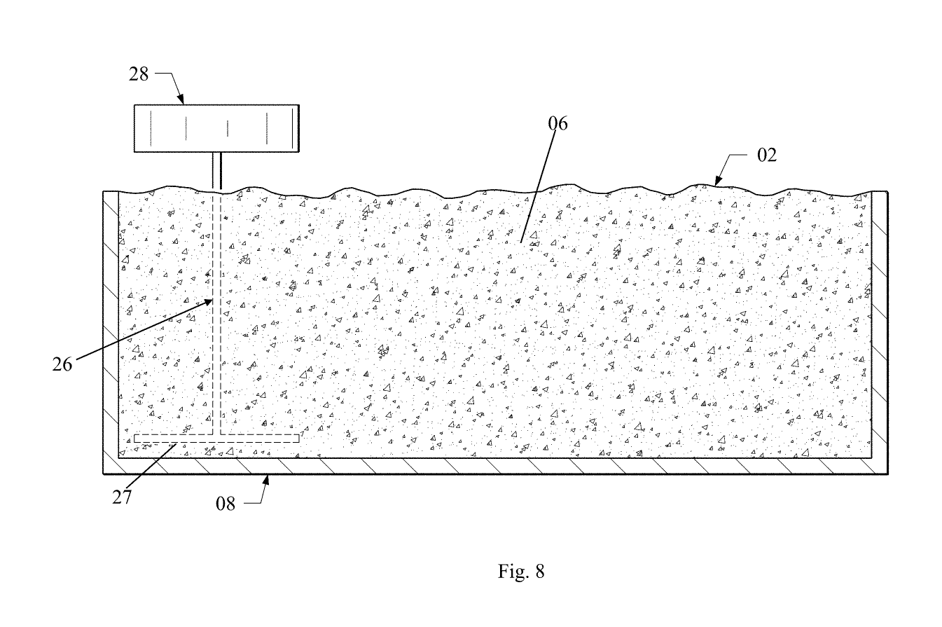

In certain configurations, a heat wick 26, such as that illustrated in FIG. 8, is included for use with a remote temperature sensor 20. The heat wick 26 includes a base section 27, a heat conducting section, and an exposure surface 28. In usage, the heat wick base 27 is submerged below the food line 02, leaving the exposure surface 28 above the food line 02 such that the heat wick base is encompassed by the food and the conducting section wicks the heat to the exposure surface 28, within the field of view 14 of the remote temperature sensor 20 for a reading.

In various configurations, the sensors 12 20 enable different fields of view 14 targeting. In certain configurations, the temperature sensor system with an integral sensor 20 includes a pivotal mount, enabling selective adjustment of the field of view 14. The embodiments incorporate a temperature sensor 20 of various configurations. In a first configuration, the temperature sensor 20 is fixably mounted where it or the cooperatively joined housing is fixably mounted toward the region for the temperature sensor 20 input. In a second configuration, the temperature sensor 20 is pivotably mounted such that the temperature sensor 20 orientation may be manipulated to select the region for the temperature sensor 20 input.

In certain configurations, the temperature sensor 20 includes a visual signature, operable for facilitating optical detection. For example, as an identifier, a temperature sensor 20 might have a certain color, pattern, or shape. The visual signature can serve to uniquely identify a particular temperature sensor 20 within a field of view 14 of an optical sensor 12.

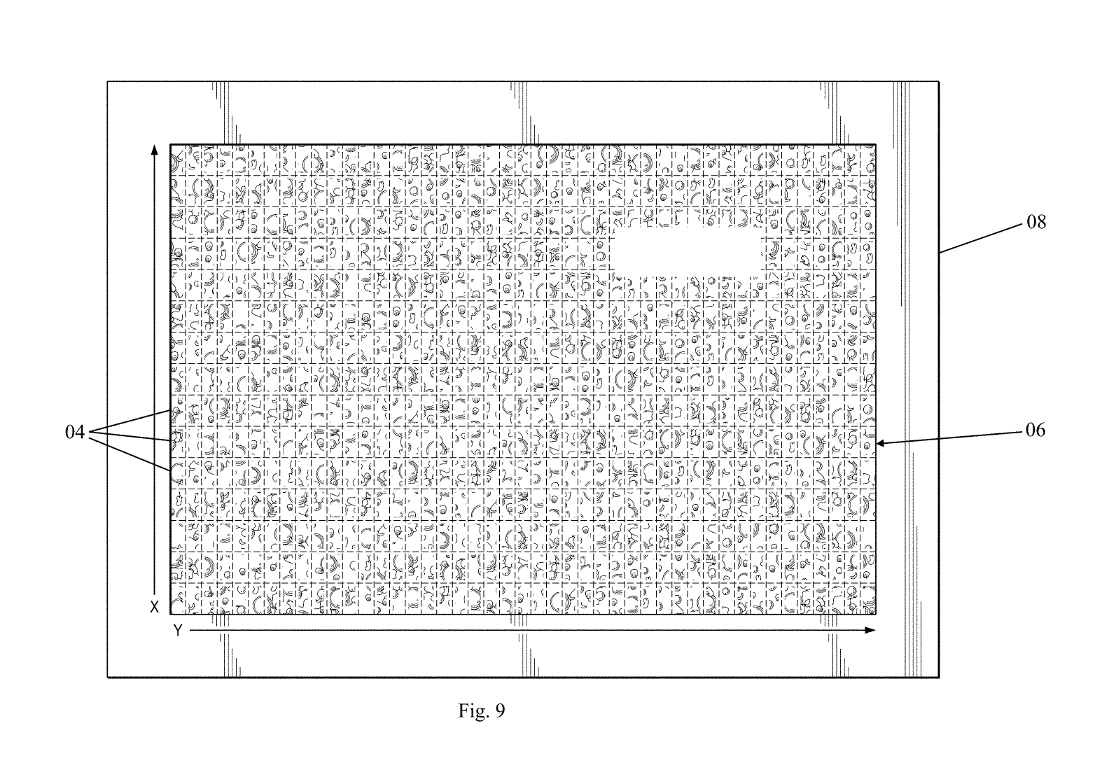

FIG. 9 illustrates a top view of a container 08 having food 06 within it. In exemplary configurations, the temperature sensor 20 is employed to receive temperature readings for the food 06 or other substrate. In some configurations, a temperature reading is taken from a position within the area (X by Y) of the food 06. A single reading can be taken. In other configurations, a reading may be taken from a select position 04. In other configurations, multiple readings from multiple positions 04 may be taken.

In certain configurations, the sensors 12 20 communicate over a network 38. Communication among sensors 12 20 and computers 30 is facilitated by a network 38. Network 38 may also include one or more wide area networks (WANs), local area networks (LANs), personal area networks (PANs), mesh networks, all or a portion of the Internet, and/or any other communication system or systems at one or more locations. Network 38 may be all or a portion of an enterprise or secured network, while in another instance at least a portion of the network 38 may represent a connection to the Internet. Further, all or a portion of network 38 may comprise either a wireline or wireless link. In other words, network 38 encompasses any internal or external network, networks, sub-network, or combination thereof operable to facilitate communications between various computing components inside and outside the illustrated environment. The network 38 may communicate by, for example, Bluetooth, Zigbee, WiFi, cellular, Internet Protocol (IP) packets, and other suitable protocols.

In certain configurations, the sensors 12 20 are in communication with a computer 30 for receipt and processing of the sensor data. A computer generally refers to a system which includes a processor, memory, a screen, a network interface, and input/output (I/O) components connected by way of a data bus. The I/O components may include for example, a mouse, keyboard, buttons, or a touchscreen. The network interface enables data communications over the network 38. Those skilled in the art will appreciate that the computer 30 may take a variety of configurations, including personal computers, hand-held devices, multi-processor systems, microprocessor-based electronics, network PCs, minicomputers, mainframe computers, and the like. Additionally, the computer 30 may be part of a distributed computer environment where tasks are performed by local and remote processing devices that are linked. Although shown as separate devices, one skilled in the art can understand that the structure of and functionality associated with the aforementioned elements can be optionally partially or completely incorporated within one or the other, such as within one or more processors.

Certain configurations of the computer 30 include memory in the form of a reporting database 36 for receipt and processing of the sensor data and storage in the reporting database 36, which can include sensor 12 20 data in pre-processed form or processed form such as the sensor data readings, sensor identifiers, images, output data, timestamps, reports, notifications, and the like.

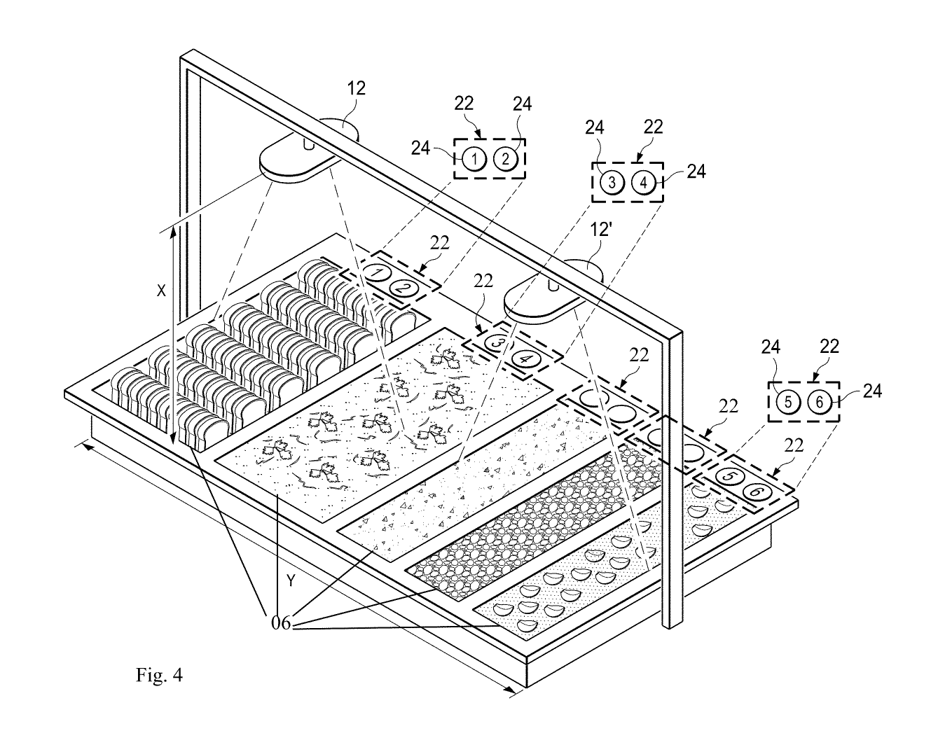

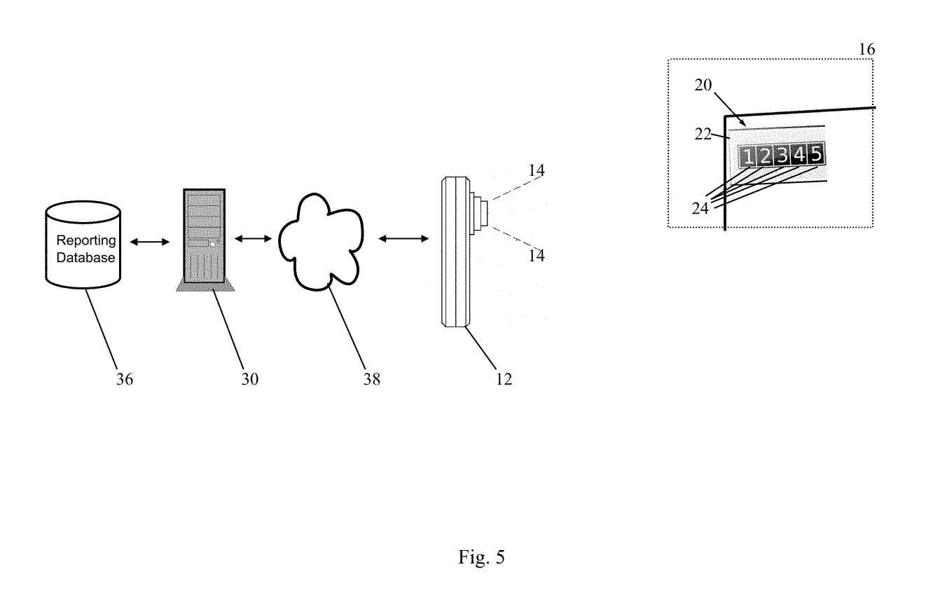

Certain embodiments of the present invention are directed to systems and processes to obtain sensor value readings from optical images of sensor readouts. FIG. 4 illustrates a top perspective view of a temperature sensor 20 displaying temperature data in a readout region 22 having individual characters 24 within the readout region 22. FIG. 5 illustrates a configuration of the system where the optical sensor 12 is employed to capture sensor readout regions 22 for temperature sensor data extraction for the food or other substrate. Depicted are an optical sensor 12, a sensor readout 22, and a computer 30.

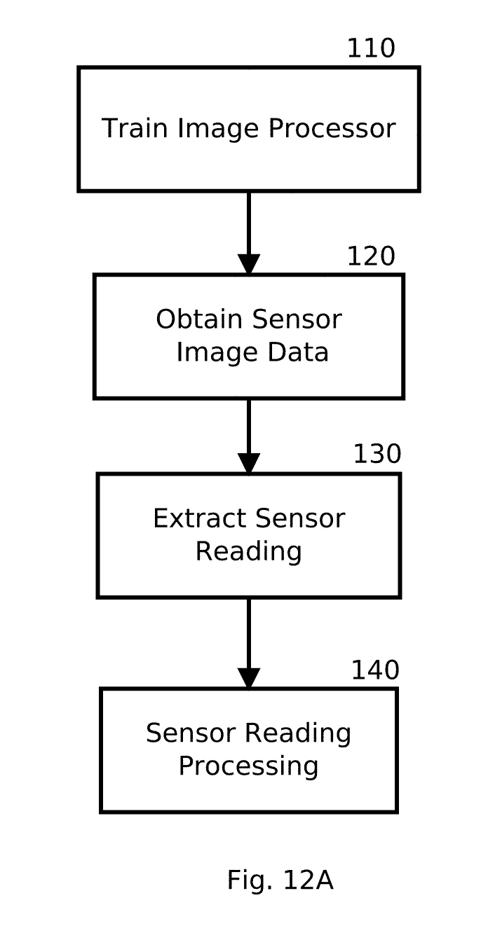

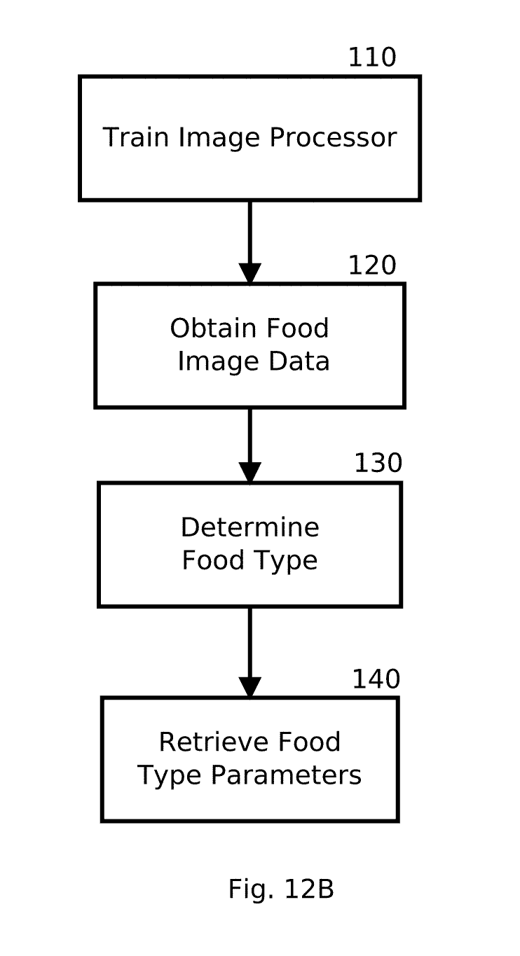

A process of obtaining sensor data readings from an optical image is illustrated in FIG. 12A. At step 110, the image processor is trained with reference images. At step 120, sensor reading images are obtained. At step 130, sensor readings are extracted from the image. At step 140, sensor reading post-processing activity occurs. Each of these steps will be considered in more detail below.

The process employs optical character recognition for image processing for character extraction. In certain configurations, a sample dataset is employed for character recognition by pattern matching, pattern recognition, image correlation, or other techniques known in the art. In certain configurations, a sample dataset is employed for character recognition by feature extraction, where image sections segmented “features” such as lines, closed loops, line direction, line intersections, corners, edges, and other identifying features. The image sections are compared with an abstract vector-like representation of a character for features detection and classification. Classifiers such as nearest neighbour classifiers such as the k-nearest neighbors algorithm are used to compare image features with stored features and a nearest threshold match is made.

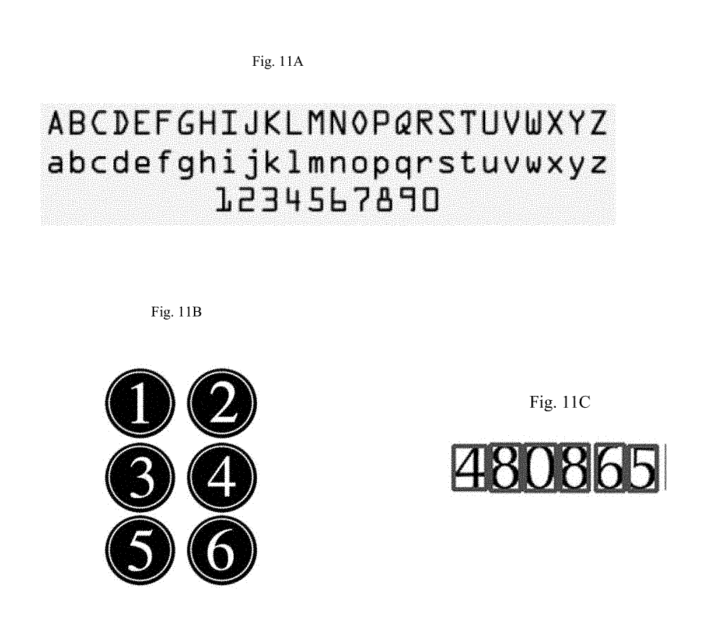

At step 110, the optical character recognition image processor is prepared or retrieved. A reference classifier image dataset is input to the system. In certain configurations, an alphanumeric dataset is input into the system. A representative partial dataset illustrated in FIG. 11A. In certain configurations, an alphanumeric dataset from the sensors to be deployed in the environment at the expected vantage point of the optical sensor 12 is input into the system. A representative partial dataset illustrated in FIG. 11B. In certain configurations, an alphanumeric dataset from the sensors to be deployed in the environment is retrieved and input into the system. Representative datasets are those from National Institute of Standards and Technology, Google. Stanford, or others. Features are extracted and stored for the reference alphanumeric images. Visual descriptors may be generated and stored for the extracted features.

An optical sensor 12 is mounted in the environment and pivoted so that its field of view 14 includes the temperature sensor data region 22. At step 120, images from the optical sensor are received. The computer 30 receives the captured image from the optical sensor 12. Representative images are shown in FIGS. 4 and 5.

At step 130, a sensor data reading is extracted from image data as alphanumeric data using techniques known in the art. The system finds matches between the reference classifier image dataset and the alphanumeric regions 24 within the sensor data readout region 22. In certain configurations, the system analyzes the image with different image processing algorithms, enhances the image, detects the sensor data region 22 position, and extracts the sensor data as alphanumeric text. In certain configurations to extract string data from the received image, the process includes the steps of receiving the image, performing a blur, detecting edges of the alphanumeric regions 24, extracting contours of the alphanumeric regions 24, getting bounding rectangles of the alphanumeric regions 24, filtering contours, binarizing and scaling the image data into the scale of the classifier dataset. In certain configurations, a 3D transformation such as homography is applied between a reference image and the subject image in order to align the two projected 2D images and better match feature points. The resulting image is input to the classifier/comparator.

Representative suitable classifiers include nearest neighbour classifiers, where the descriptors as mapped a points in a cartesian/multidimensional space, with a match is defined in terms of a measure of distance between the points. Descriptors that are close enough to each other are considered a match. When a pair of descriptors is a match, the underlying pair of features is assumed a match. The corresponding index text to the matched image is returned as part of the string text of the sensor data reading.

After conversion and extraction of the image to the alphanumeric string data representing the sensor reading, post-sensor reading activity occurs 140. Post-sensor reading activity includes storing the data, monitoring the data, notifications, and reporting. In certain configurations, the system receives and records the sensor reading data in the reporting database 36.

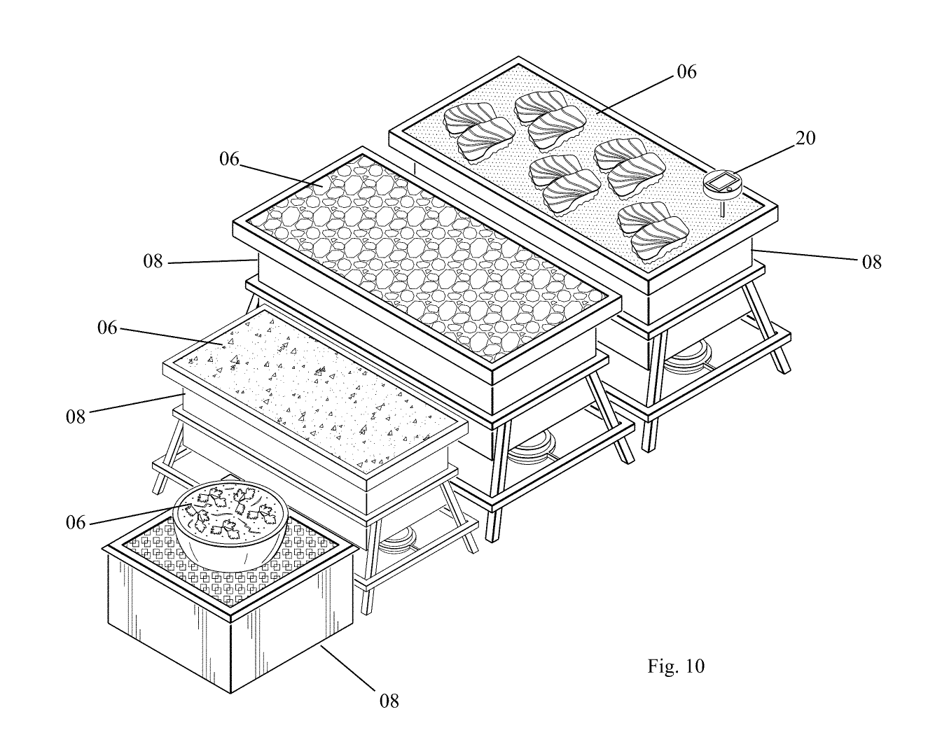

FIG. 10 illustrates a top perspective view of a separate food 06 items, each in a separate container 08, where it is desirable to individually monitor the temperature for the food 06 in each container 08. In certain configurations, the optical sensor 12 is employed as a basis to recognize the visual signature for each food 06 item, detecting the type of food item for further processing, such as retrieving its temperature range.

A process of classifying food from optical image data is illustrated in FIG. 12B. At step 110, the image processor is trained with reference images. At step 120, food images are obtained. At step 130, food types are determined from the image captures. At step 140, parameters are retrieved for the food type. Each of these steps will be considered in more detail below.

An exemplary process employs computer vision and machine learning for image processing for food type classification. In certain configurations, a sample dataset is employed for food recognition by pattern matching, pattern recognition, image correlation, or other techniques known in the art. In certain configurations, a sample dataset is employed for food classification by algorithms such as by feature extraction, bag-of-features model coupled, support vector machine, deep learning, neural networks, or other processes known in the art.

At step 110, the food classification image processor is prepared or retrieved. A pre-trained classifier may be employed. A reference classifier image dataset is input to the system. In certain configurations, a food dataset such as the University of Milano-Bicocca 2016 food image dataset is input into the system. Among the above measurement methods, a corresponding image dataset is in need, which is used to train and test the object detection algorithm. Additional food image datasets such as Food-101, Pittsburgh Fast-food Image Dataset, or FOODD may be employed for food images under different visual conditions.

Learning algorithms are applied to the food image datasets. For example, one or more algorithms, such as the bag-of-features model, Support Vector Machine, Scale invariant feature transform (SIFT) descriptors, neural networks (deep neural networks, conversational networks, or otherwise) may be applied to the image datasets. Features are extracted and stored for the reference food classifiers. Visual signatures may be generated and stored for the extracted features.

An optical sensor 12 is mounted in the environment and pivoted so that its field of view 14 includes a food 06 item. At step 120, images from the optical sensor are received. The computer 30 receives the captured image from the optical sensor 12. Representative images are individual food items shown in FIG. 10.

At step 130, a food type is determined from the image data using the food classification signature. The system finds likely matches between the image data and the classifier. In certain configurations, the system analyzes the image with different image processing algorithms, enhances the image, detects the food position, and classify the food type from the visual signature.

After determination of the food type from the image, food type parameters are retrieved 140. Exemplary food type parameters includes an optimal temperature ranges for the determined food type. Related activity can include storing the data, monitoring the data, notifications, and reporting. In certain configurations, the system receives and records the food type in the reporting database 36.

FIG. 1-5 illustrate environments where the systems and processes of the current invention may be deployed. A representative environment is a food buffet with food 06 being placed in separate containers 08, with temperature sensors 20 paired with each container 08 of food 06. The temperature sensors 20 provide numeric sensor data in their respective sensor data regions 22. Optical sensors 12 are mounted on the ceiling and pivoted to include the temperature sensors 20 in their respective fields of view. The optical sensors 12 are networked with a computer 30 for transmission of their image data. An image processor with a reference dataset of alphanumeric images is deployed to the computer 110. The optical sensors 12 periodically transmit their image data of the sensor data regions 22 to the computer 120. The computer 30 extracts string data values from the image data 130. The computer 30 stores string values from the image data in the reporting database 140.

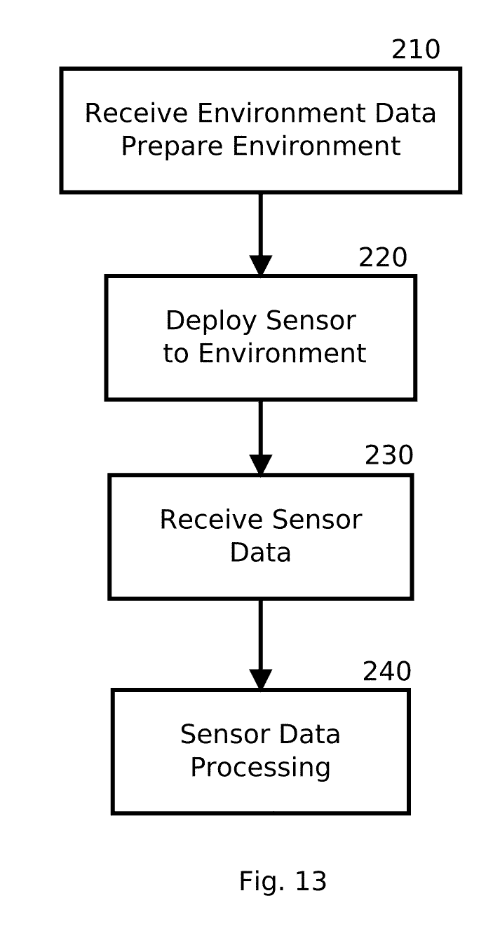

A process of obtaining sensor data readings from an optical image is illustrated in FIG. 13. At step 210, the environment data is received and the environment is prepared. At step 220, a temperature reader with an integral sensor 12 is deployed to the environment. At step 230, sensor data is received. At step 240, sensor reading processing and post-processing activity occurs. Each of these steps will be considered in more detail below.

At step 210, the environment data is received and the environment is prepared. FIGS. 1-5 illustrate representative environments. The environment includes the substrate 06 to be monitored, such as food. The food 06 is in a controlled volume of space that is amenable to being scanned, for example by optical scanning and/or scanning with a temperature sensor that scans the controlled volume of space. Depending on the volume and other factors, further scanning may be desirable to scan the entire volume of space wherein the persons are present. Nonexclusive factors for consideration are the volume and area of the space to be monitored (X by Y by Z), the type of material to be monitored, the distance Z from the sensor 20 to the material to be monitored, and other factors, the expected temperature range within the area to be monitored, the expected variance of temperature within the area to be monitored or the material to be monitored, the area or height of the material to be monitored, the likelihood of the view being impeded during operation, and other factors. Each food 06 item may be placed in a known position.

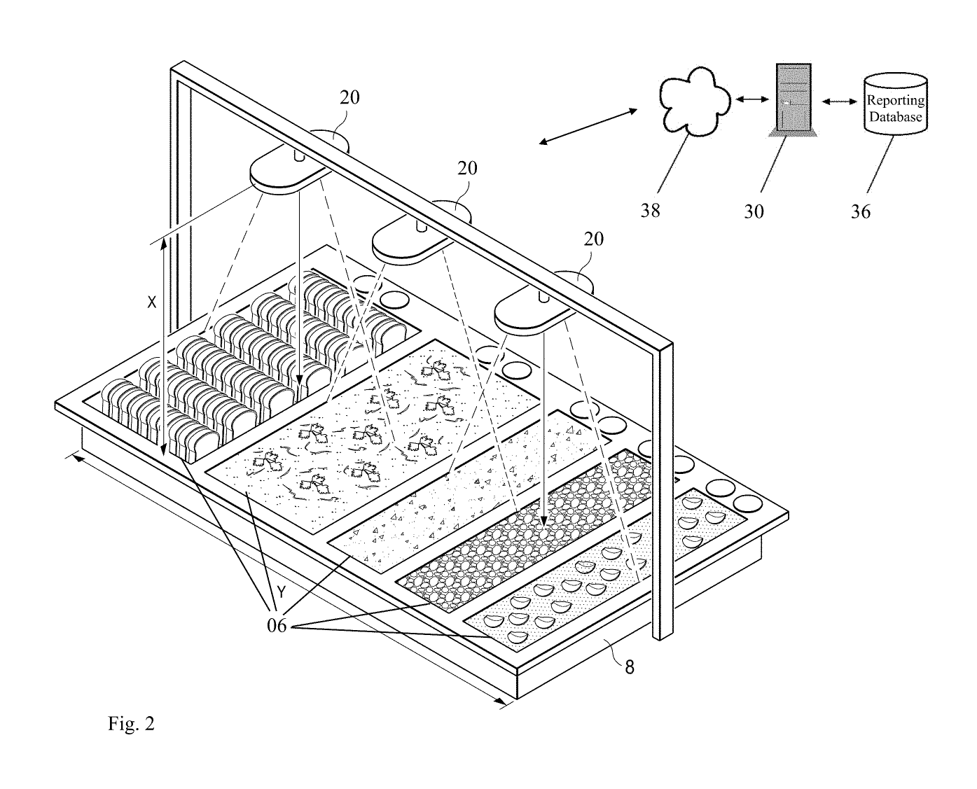

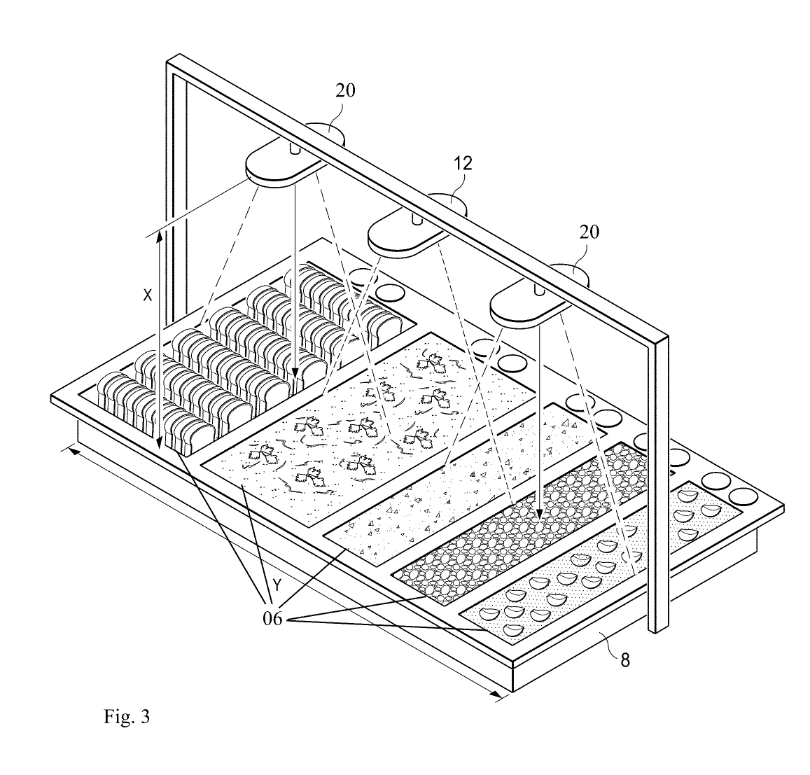

The environment is configured according to the received information for the particular environment. For example, FIG. 1 illustrates an environment with multiple food items 06 in separate containers 08 with multiple remote temperature sensors 20 deployed. FIG. 2 illustrates an environment with multiple food items 06 in separate containers 08 with multiple remote temperature sensors 20 deployed and a reporting database. FIG. 3 illustrates an environment with multiple food items 06 in separate containers 08 with temperature sensors 20 and optical sensors 12 deployed. FIG. 4 illustrates an environment with multiple food items 06 in separate containers 08 with probe temperature sensors 20 having readout regions 22 and optical sensors 12 deployed.

One or more temperature sensors 20 are deployed to the environment 220. Each is mounted in the environment so that its field of view 14 includes one or more food items 06 to be monitored. Where a remote temperature sensor is deployed, the remote temperature sensor 20 is aligned to receive a signal that it is reflected inward from the material to be monitored. Where a probe temperature sensor 20 is deployed, a probe temperature sensor 20 with its readout region 22 aligned for visibility to the optical sensor 12. In certain configurations, an optical sensor 12 is mounted such that its field of view 14 includes a similar field of view 14 as the temperature sensors 20 and/or food items 06. Where a remote temperature sensor 20 is deployed, a heat wick 26 may be placed in food items 06, with the base 27 submerged in the food item 06 and the exposure surface 28 above the food line 02. Where a wireless or wired temperature sensor 20 is deployed, it connection over the network 38 is established.

Sensor identification can be established for data tracking and association with food items 06. For example, where a remote temperature sensor is deployed, the physical position can enable association with food items 06. Where a probe temperature sensor 20 is deployed, it may be deployed with a unique visual signature for its identification. In certain configurations, an optical sensor 12 is mounted such that its field of view 14 includes a similar field of view 14 as the temperature sensors 20 and/or food items 06. Where a wireless or wired temperature sensor 20 is deployed, it may transmit a unique identifier.

The illustration of FIG. 1 depicts a series of temperature sensors 20 mounted at spaced positions to provide temperature data for food items 06 in containers 08. In the illustrated example, the detection zones may overlap, although that overlap is not necessary. The detection zone of scanning temperature sensor 20, at a distance Z from the temperature sensor 20, is defined by a volume. The volume has a rectangular vertical face having a perimeter of a pair of vertical opposed sides and horizontal opposed sides; and the longitudinal sides of the volume are defined by longitudinally lower extending opposed sides and upper extending opposed sides. Likewise, a second temperature sensor 20 has a detection zone that overlaps with detection zone of the first temperature sensor 20, in the illustrated example. Detection zones not of the shape presented in these examples are within the spirit of this invention, as detection zone shapes may vary widely.

At step 230, sensor data reading is received from the temperature sensors 20. Temperature reading for each of the food items 06 are transmitted to a database 36 of the server 30. Where a remote temperature sensor 20, wired or wireless temperature sensor 20 is deployed, the sensor data reading is received and transmitted over the network. Where a probe temperature sensor 20 with a readout region 22 with is deployed, its image data is received by the optical sensor 12 and by optical character recognition of the readout characters 24, the sensor reading data is extracted and the sensor data reading is received. Representative data includes a timestamp, a scanner identifier, a sensor identifier, ambient temperature, and food temperature. This temperature information may include temperature information of different sample points with the monitored zone, as shown in FIG. 9 by the different grid elements 04 and focus region. In varying configurations, the temperature information may be averaged over an area or transmitted in whole along with position information.

After receipt of the temperature sensor 20 reading data, post-sensor reading activity occurs 240. The system optionally adjusts the temperature received from the temperature sensor 20′ based on the distance of the subject. The system can employ received environmental information, a distance sensor, image data from an optical camera(s), black body temperature reference, or other means in the art to determine the distance of the subject. Other post-sensor reading activity includes storing the data, monitoring the data, notifications, and reporting. In certain configurations, the system receives and records the sensor reading data in the reporting database 36.

In certain environments, it may be desirable to generate notifications in response to sensor reading values. For example, where the sensor is a temperature sensor 20, it may be desirable to generate a notification when the sensor reading is outside lower and upper bounds. In response to the extracted sensor reading, the computer 30 can generate a notification when the sensor reading it outside certain thresholds.

In certain environments, it may be desirable to generate reports from historical sensor values. When problems occur after a cycle of a monitored process, compliance reports may be used to review the process and any deviations that occurred during that specific cycle. Compliance reports can be generated which show historical sensor readings which, in turn, show deviations from optimum values during a monitored process and can trigger action to apply control in order prevent, eliminate, or reduce food safety hazards.

Again, in certain environments, it may be desirable to generate notifications in response to sensor reading values. For example, where the sensor is a temperature sensor 20, it may be desirable to generate a notification when the sensor reading is outside lower and upper bounds. In response to the extracted sensor reading, the computer 30 can generate a notification when the sensor reading it outside certain thresholds. In certain configurations, the thresholds are manually set for a given food item 06. In certain configurations, the thresholds are manually set for a given physical position. In certain configurations, the thresholds are set based on computer vision processing of the monitored zone. To illustrate, the optical camera 12 provides image data of the monitored zone. Using the image data from the optical camera, the food 06 type is determined and threshold temperature values are retrieved. In turn, a threshold temperature is returned corresponding to that food type.

The server 30 may generate visual output on monitor at a workstation that may also permit data input, for example via keyboard and mouse. In certain embodiments, the system provides an alert when an out of range temperature is detected. The alert may be audible, visual, or both and may also be transmitted to appropriate parties wirelessly or by other means.

Again, in certain environments, it may be desirable to generate reports from historical sensor values. When problems occur after a cycle of a monitored process, compliance reports may be used to review the process and any deviations that occurred during that specific cycle. Compliance reports can be generated which show historical sensor readings which, in turn, show deviations from optimum values during a monitored process and can trigger action to apply control in order prevent, eliminate, or reduce food safety hazards.

Insofar as the description above and the accompanying drawing disclose any additional subject matter that is not within the scope of the single claim below, the inventions are not dedicated to the public and the right to file one or more applications to claim such additional inventions is reserved.

What is claimed is:

1. A system for monitoring the temperature of food, said system comprising:
a temperature sensor configured to provide temperature reading output of said food;
a computer comprising a processor, memory, a network adapter, and a reporting database;
said reporting database configured to store temperature reading output of said food.

2. The system of claim 1, wherein said temperature sensor is a remote temperature sensor.

3. The system of claim 2, further comprising a heat wick, said heat wick comprising a base, a conducting section, and an exposure surface providing a surface for said remote temperature sensor.

4. The system of claim 1, wherein said remote temperature sensor further comprises a pivotal mount, operable to enable manipulation of its field of view.

5. The system of claim 1, wherein said temperature sensor includes a wireless transmitter and said network adapter is wireless network adapter.

6. The system of claim 1, wherein said temperature sensor is a probe sensor having a sensor readout region operable to display a temperature sensor value;
further comprising an optical sensor configured to transmit image data of said sensor readout region, said computer configured to extract sensor data values from said image data.

7. The system of claim 1, wherein said temperature sensor includes a visual signature;
further comprising an optical sensor configured to transmit image data of said temperature sensor to said computer, said computer configured to detect said visual signature and associate sensor readings with temperature sensors matching said visual signature.

8. The system of claim 1, wherein said computer generates a notification in response to a temperature sensor value being outside a threshold range for said food.

9. The system of claim 8, wherein said system provides an input for receipt of said threshold.

10. The system of claim 8, further comprising an optical sensor configured to transmit image data of said food to said computer, said computer configured to detect said visual signature of said food, classify said food to a food type, and retrieve said threshold temperature value for said food type matching said visual signature.

11. A process for monitoring the temperature of food, said process comprising:
providing a computer having a processor, memory, a network adapter, and a reporting database;
receiving the environment data for said food, including position information and the food type to be monitored;
deploying a temperature sensor to food within said environment, said temperature sensor configured to provide temperature reading output of said food;
said computer receiving said temperature reading output from said temperature sensor;
said computer storing temperature reading output of said food in said reporting database.

12. The process of claim 11, wherein said temperature sensor is a remote temperature sensor.

13. The process of claim 12, further providing a heat wick, said heat wick comprising a base, a conducting section, and an exposure surface providing a surface for said remote temperature sensor.

14. The process of claim 11, wherein said remote temperature sensor further comprises a pivotal mount, operable to enable manipulation of its field of view.

15. The process of claim 11, wherein said temperature sensor includes a wireless transmitter and said network adapter is wireless network adapter.

16. The process of claim 11, wherein said temperature sensor is a probe sensor having a sensor readout region operable to display a temperature sensor value;
further comprising an optical sensor configured to transmit image data of said sensor readout region, said computer configured to extract sensor data values from said image data.

17. The process of claim 11, wherein said temperature sensor includes a visual signature, said visual signature being a color;
further comprising an optical sensor configured to transmit image data of said temperature sensor to said computer, said computer configured to detect said visual signature and associate sensor readings with temperature sensors matching said visual signature.

18. The process of claim 11, wherein said computer generates a notification in response to a temperature sensor value being outside a threshold range for said food.

19. The process of claim 18, wherein said system provides an input for receipt of said threshold.

20. The process of claim 18, further providing an optical sensor configured to transmit image data of said food to said computer, said computer configured to detect said visual signature of said food, classify said food to a food type, and retrieve said threshold temperature value for said food type matching said visual signature.
